(19) United States
(12) Patent Application Publication
(10) Pub. No.: US 2026/0156694 A1
(43) Pub. Date: Jun. 4, 2026

(54) ACCESS LINK MANAGEMENT NOTIFICATION USING A DEVICE-TO-DEVICE LINK

(71) Applicant: QUALCOMM Incorporated, San Diego, CA (US)

(72) Inventors: Rajeev Kumar SINGH, Hyderabad (IN); Imran ANSARI, Hyderabad (IN); Shankar J, Hyderabad (IN)

(21) Appl. No.: 18/966,591

(22) Filed: Dec. 3, 2024

(51) Int. Cl. H04W 76/14; H04W 48/14; H04W 84/12

(52) U.S. Cl. CPC H04W 76/14; H04W 48/14; H04W 84/12

(57) ABSTRACT

In some aspects, a first wireless station (STA) may receive, in an access link with an access point, an access link management notification that indicates configuration information associated with the access link. The STA may transmit, in a device-to-device (D2D) link with a second STA, an indication of the access link management notification. Numerous other aspects are described.

### FIELD OF THE DISCLOSURE

Aspects of the present disclosure generally relate to a wireless network and, for example, to an access link management notification using a device-to-device link.

### BACKGROUND

A wireless network, such as a wireless local area network (WLAN), may provide connectivity to client devices based at least in part on a centralized network infrastructure. To illustrate, the WLAN may be formed by one or more wireless access points (APs) that provide a shared wireless communication medium to multiple client devices that may also referred to as wireless stations (STAs). A basic building block that a WLAN uses to conform to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN. A first STA may connect to an AP via an access link and, in some cases, may establish a device-to-device link with a second STA. The device-to-device link may differ from the access link connection insofar as the device-to-device link may not rely upon a centralized network infrastructure. Instead, the device-to-device link may be a direct link that does not use an intermediary network node (e.g., an AP). Maintaining both an access link and a device-to-device link may enable the STA to optimize connectivity, such as by using the access link for access to broader services (e.g., the Internet) and by using the device-to-device link with nearby devices to reduce data transfer latencies.

### SUMMARY

Some aspects described herein relate to a method of wireless communication performed by a first wireless station (STA). The method may include receiving, in an access link with an access point (AP), an access link management notification that indicates configuration information associated with the access link. The method may include transmitting, in a device-to-device (D2D) link with a second STA, an indication of the access link management notification.

Some aspects described herein relate to a method of wireless communication performed by a second STA. The method may include establishing an access link with an AP. The method may include establishing a D2D link with a first STA. The method may include receiving, in the D2D link, an indication of an access link management notification that indicates configuration information associated with the access link.

Some aspects described herein relate to an apparatus for wireless communication at a first STA. The apparatus may include one or more memories and one or more processors coupled to the one or more memories. The one or more processors may be configured to receive, in an access link with an AP, an access link management notification that indicates configuration information associated with the access link. The one or more processors may be configured to transmit, in a D2D link with a second STA, an indication of the access link management notification.

Some aspects described herein relate to an apparatus for wireless communication at a second STA. The apparatus may include one or more memories and one or more processors coupled to the one or more memories. The one or more processors may be configured to establish an access link with an AP. The one or more processors may be configured to establish a D2D link with a first STA. The one or more processors may be configured to receive, in the D2D link, an indication of an access link management notification that indicates configuration information associated with the access link.

Some aspects described herein relate to a non-transitory computer-readable medium that stores a set of instructions for wireless communication by a first STA. The set of instructions, when executed by one or more processors of the STA, may cause the STA to receive, in an access link with an AP, an access link management notification that indicates configuration information associated with the access link. The set of instructions, when executed by one or more processors of the STA, may cause the STA to transmit, in a D2D link with a second STA, an indication of the access link management notification.

Some aspects described herein relate to a non-transitory computer-readable medium that stores a set of instructions for wireless communication by a second STA. The set of instructions, when executed by one or more processors of the STA, may cause the STA to establish an access link with an AP. The set of instructions, when executed by one or more processors of the STA, may cause the STA to establish a D2D link with a first STA. The set of instructions, when executed by one or more processors of the STA, may cause the STA to receive, in the D2D link, an indication of an access link management notification that indicates configuration information associated with the access link.

Some aspects described herein relate to an apparatus for wireless communication. The apparatus may include means for receiving, in an access link with an AP, an access link management notification that indicates configuration information associated with the access link. The apparatus may include means for transmitting, in a D2D link with a STA, an indication of the access link management notification.

Some aspects described herein relate to an apparatus for wireless communication. The apparatus may include means for establishing an access link with an AP. The apparatus may include means for establishing a D2D link with a STA. The apparatus may include means for receiving, in the D2D link, an indication of an access link management notification that indicates configuration information associated with the access link.

Aspects generally include a method, apparatus, system, computer program product, non-transitory computer-readable medium, user device, user equipment, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 shows a diagram of an example wireless communication environment.

FIG. 2 is a diagram illustrating example components of a device, in accordance with the present disclosure.

FIG. 3 is a diagram illustrating an example of a critical update procedure, in accordance with the present disclosure.

FIG. 4 is a diagram illustrating an example of a wireless communication process between an access point, a first wireless station (STA), and a second STA, in accordance with the present disclosure.

FIG. 5 is a flowchart of an example process associated with access link management notification using a device-to-device (D2D) link, in accordance with the present disclosure.

FIG. 6 is a flowchart of an example process associated with access link management notification using a D2D link, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

An access point (AP) in a wireless local area network (WLAN) may communicate updates associated with the WLAN configuration to one or more wireless stations (STAs) to optimize a performance of the wireless network, such as updates that are configured to increase data throughput, decrease data recovery errors, and/or decrease data transfer latencies. The AP may iteratively and/or dynamically communicate the updates based at least in part on changes to an operating environment, such as load changes, channel property changes, and/or signal interference changes. As an example, the AP may transmit a critical update, where “critical update” denotes explicit signaling that indicates an update and/or a change to one or more basic service set (BSS) parameters. To illustrate, in a high-density operating environment that includes multiple STAs being connected to the AP, the AP may modify BSS coloring to reduce co-channel interference, where BSS coloring assigns unique identifiers and/or colors to overlapping networks on a same channel to mitigate interference. As another example, the AP may modify BSS parameters that help load balancing and/or result in one or more STAs switching over to a less-congested AP. In some cases, a premise of using critical updates is that the STAs receiving the critical updates take action and/or apply the indicated updates within a time window to ensure continuity in the WLAN.

STAs operating with a same WLAN and/or connected to a same AP may include varying capabilities. For instance, a first STA in the form of a mobile phone or a laptop may include more transceivers and/or antennas relative to a second STA that is in the form of a wearable device, such as a smart watch, and/or an Internet of things (IoT) device. The second STA having fewer transceivers and/or antennas relative to the first STA may reduce the second STA's ability to mitigate receiver multipath effects relative to the first STA. As another example, the first STA may have a larger power supply (e.g., a battery with larger power storage) relative to the second STA. To preserve power that is stored in a battery, some STAs may operate in a power saving mode (PSM) that includes the STA alternating between a sleep state that reduces power consumption and an active state that enables transmission and/or reception by the STA. Some STAs may configure a duration of a sleep state at least in part on a delivery traffic indication message (DTIM) that is transmitted by an AP and indicates when an STA should transition to the active state for data delivery (e.g., buffered data). The AP may transmit a DTIM in every n-th beacon frame, and the STA may transition from a sleep state to an active state every n-th beacon frame to receive the DTIM. The STA may then analyze information indicated by the DTIM to determine whether to remain in the active state to receive any buffered data (e.g., broadcast data and/or multicast data) or whether to return to the sleep state.

“Low-power device” denotes a computing device (e.g., an STA) that includes a power source with a power storage level that satisfies a low power threshold. Examples of low-power devices may include a wearable device and/or an IoT device. In some cases, a low-power device may operate in a modified PSM mode that extends a sleep state and/or reduces the frequency of the low-power device transitioning to an active state in order to conserve more power, such as by extending the sleep state and not transitioning to the active state every n-th beacon frame to receive the DTIM. The extended sleep state may result in the low-power device missing a critical update. Moreover, as described above, some low-power devices may be more susceptible to receiver multipath and/or less equipped to mitigate receiver multipath, and missing the critical update in combination with reduced receiver capabilities may lead to the low-power device operating out-of-sync with an AP and may result in increased data recovery errors, increased data transfer latencies (e.g., data stalling), decreased data throughput, and/or increased disconnects with the AP.

Various aspects relate generally to managing notifications in a wireless network. Some aspects more specifically relate to an access link management notification using a device-to-device (D2D) link. In some aspects, a first STA may receive, in an access link with an AP, an access link management notification that indicates configuration information associated with the access link. For instance, the first STA may receive, as the link management notification, a beacon frame in the access link, and the beacon frame may include a critical update. Based at least in part on receiving the access link management notification, the first STA may transmit, in a D2D link with a second STA, an indication of the access link management notification.

In some aspects, a second STA may establish an access link with an access point and may establish a D2D link with a first STA. The second STA may receive, in the D2D link, an indication of an access link management notification that indicates configuration information associated with the access link.

Particular aspects of the subject matter described in this disclosure can be implemented to realize one or more of the following potential advantages. In some examples, by a first STA indicating an access link management notification to a second STA via a D2D link, the described techniques can be used to increase power savings at the second STA and mitigate the second STA missing a critical update. For instance, the second STA may register with the first STA to receive the access link management notifications via the D2D link and may extend a sleep state duration to reduce power consumption. The first STA may monitor for the access link management notifications and may forward the access link management notifications to the second STA during an active state of the second STA to ensure that the second STA has received critical updates and remains synchronized with a wireless network. Reducing power consumption at the second STA may extend an operating duration of the second STA and ensure that the second STA is synchronized in the wireless network, resulting in reduced recovery errors, increased data throughput, reduced data transfer latencies, and/or reduced disconnects.

Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3^{rd} Generation Partnership Project (3GPP), among others. The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a WLAN, a wireless wide area network (WWAN), a wireless metropolitan area network (WMAN), a non-terrestrial network (NTN), or an IoT network.

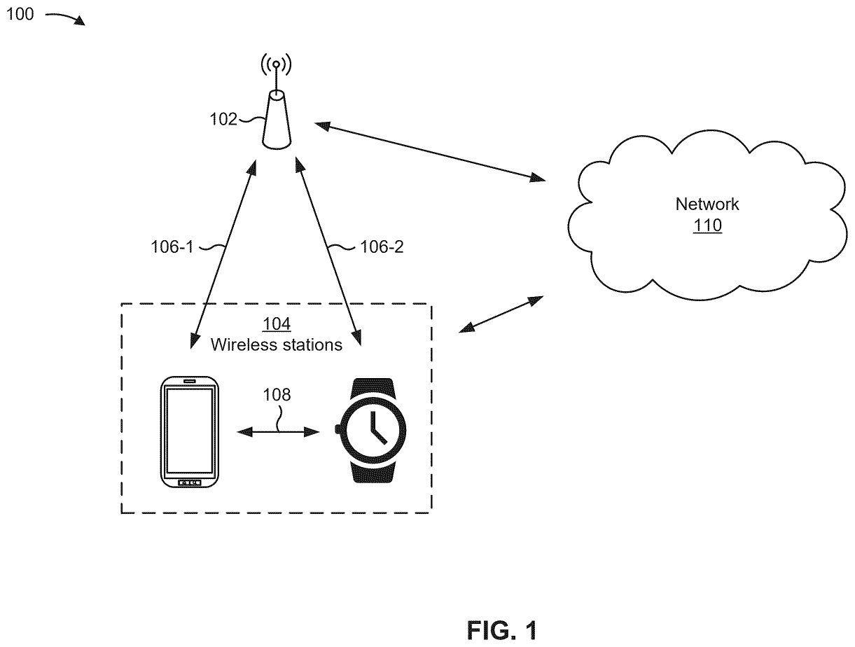

FIG. 1 shows a pictorial diagram of an example wireless communication environment 100.

The wireless communication environment 100 may include numerous wireless communication devices including at least one wireless AP 102 and any number of wireless stations (STAs) 104. While only one AP 102 is shown in FIG. 1, the wireless communication environment 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices, such as mobile phones (e.g., smart phones), other handheld or wearable communication devices (e.g., smart watches), netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), IoT devices, and vehicles, among other examples.

A single AP 102 and an associated set of STAs 104 may be referred to as a BSS, which is managed by the respective AP 102. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link (hereinafter also referred to as a “Wi-Fi link”) with each wireless station, shown by FIG. 1 as a communication link 106-1 and a communication link 106-2, or to maintain the respective communication link (e.g., the communication link 106-1 and/or the communication link 106-2), with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication environment 100 via respective communication links.

To establish the communication link 106-1 and/or the communication link 106-2 with an AP 102, each of the STAs 104 may be configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 may listen for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a respective communication link (e.g., the communication link 106-1 and/or the communication link 106-2) with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication environment 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network. In such examples, while the STAs 104 may be capable of communicating with each other through the AP 102 using the communication link 106-1 and the communication link 106-2, STAs 104 also can communicate directly with each other via a WPAN link 108. Additionally, two STAs 104 may communicate via a WPAN link 108 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of the WPAN link 108 include a Bluetooth link, a Bluetooth low energy (BLE) link, or any other suitable P2P group connection.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication environment 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR 4 (52.6 GHz-114.25 GHz), and FR 5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

According to some aspects, the wireless communication environment 100 may include a wireless communication network 110. The wireless communication network 110 can be an example of a WLAN such as a Wi-Fi network. For example, the wireless communication network 110 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bc, 802.11bd, 802.11be, 802.11bf, and 802.11bn). In some other examples, the wireless communication network 110 can be an example of a cellular RAN, such as a 5G or 6G RAN that implements one or more cellular protocols such as those specified in one or more 3GPP standards. In some other examples, the wireless communication network 110 can include a WLAN that functions in an interoperable or converged manner with one or more cellular RANs to provide greater or enhanced network coverage to wireless communication devices within the wireless communication network 110 or to enable such devices to connect to a cellular network's core, such as to access the network management capabilities and functionality offered by the cellular network core. In some other examples, the wireless communication network 110 can include a WLAN that functions in an interoperable or converged manner with one or more personal area networks, such as a network implementing Bluetooth or other wireless technologies, to provide greater or enhanced network coverage or to provide or enable other capabilities, functionality, applications or services. In some examples, the wireless communication network 110 may include the APs 102 and/or the STAs 104.

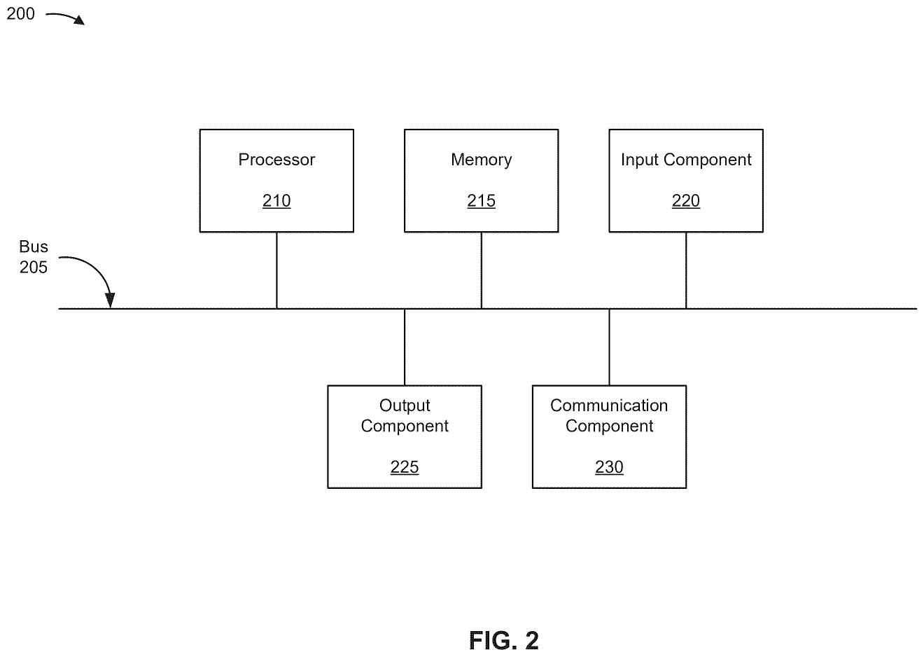

FIG. 2 is a diagram illustrating example components of a device 200, in accordance with the present disclosure. The device 200 may correspond to a STA. In some aspects, the STA 104 may include one or more devices 200 and/or one or more components of the device 200. As shown in FIG. 2, the device 200 may include a bus 205, a processor 210, a memory 215, an input component 220, an output component 225, and/or a communication component 230.

The bus 205 may include one or more components that enable wired and/or wireless communication among the components of the device 200. The bus 205 may couple together two or more components of FIG. 2, such as via operative coupling, communicative coupling, electronic coupling, and/or electric coupling. For example, the bus 205 may include an electrical connection (e.g., a wire, a trace, and/or a lead) and/or a wireless bus. The processor 210 may include a central processing unit, a graphics processing unit, a microprocessor, a controller, a microcontroller, a digital signal processor, a field-programmable gate array, an application-specific integrated circuit, and/or another type of processing component. The processor 210 may be implemented in hardware, firmware, or a combination of hardware and software. In some aspects, the processor 210 may include one or more processors capable of being programmed to perform one or more operations or processes described elsewhere herein.

The memory 215 may include volatile and/or nonvolatile memory. For example, the memory 215 may include random access memory (RAM), read only memory (ROM), a hard disk drive, and/or another type of memory (e.g., a flash memory, a magnetic memory, and/or an optical memory). The memory 215 may include internal memory (e.g., RAM, ROM, or a hard disk drive) and/or removable memory (e.g., removable via a universal serial bus connection). The memory 215 may be a non-transitory computer-readable medium. The memory 215 may store information, one or more instructions, and/or software (e.g., one or more software applications) related to the operation of the device 200. In some aspects, the memory 215 may include one or more memories that are coupled (e.g., communicatively coupled) to one or more processors (e.g., processor 210), such as via the bus 205. Communicative coupling between a processor 210 and a memory 215 may enable the processor 210 to read and/or process information stored in the memory 215 and/or to store information in the memory 215.

The input component 220 may enable the device 200 to receive input, such as user input and/or sensed input. For example, the input component 220 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 225 may enable the device 200 to provide output, such as via a display, a speaker, and/or a light-emitting diode. The communication component 230 may enable the device 200 to communicate with other devices via a wired connection and/or a wireless connection. For example, the communication component 230 may include a receiver, a transmitter, a transceiver, a modem, a network interface card, and/or an antenna.

The device 200 may perform one or more operations or processes described herein. For example, a non-transitory computer-readable medium (e.g., memory 215) may store a set of instructions (e.g., one or more instructions or code) for execution by the processor 210. The processor 210 may execute the set of instructions to perform one or more operations or processes described herein. In some aspects, execution of the set of instructions, by one or more processors 210, causes the one or more processors 210 and/or the device 200 to perform one or more operations or processes described herein. In some aspects, hardwired circuitry may be used instead of or in combination with the instructions to perform one or more operations or processes described herein. Additionally, or alternatively, the processor 210 may be configured to perform one or more operations or processes described herein. Thus, aspects described herein are not limited to any specific combination of hardware circuitry and software.

In some aspects, device 200 may include means for receiving, in an access link with an AP, an access link management notification that indicates configuration information associated with the access link; and/or means for transmitting, in a D2D link with a second STA, an indication of the access link management notification. In some aspects, device 200 may include means for establishing an access link with an AP; means for establishing a D2D link with a first STA; and/or means for receiving, in the D2D link, an indication of an access link management notification that indicates configuration information associated with the access link. In some aspects, the means for device 200 to perform processes and/or operations described herein may include one or more components of device 200 described in connection with FIG. 2, such as bus 205, processor 210, memory 215, input component 220, output component 225, and/or communication component 230.

The number and arrangement of components shown in FIG. 2 are provided as an example. The device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

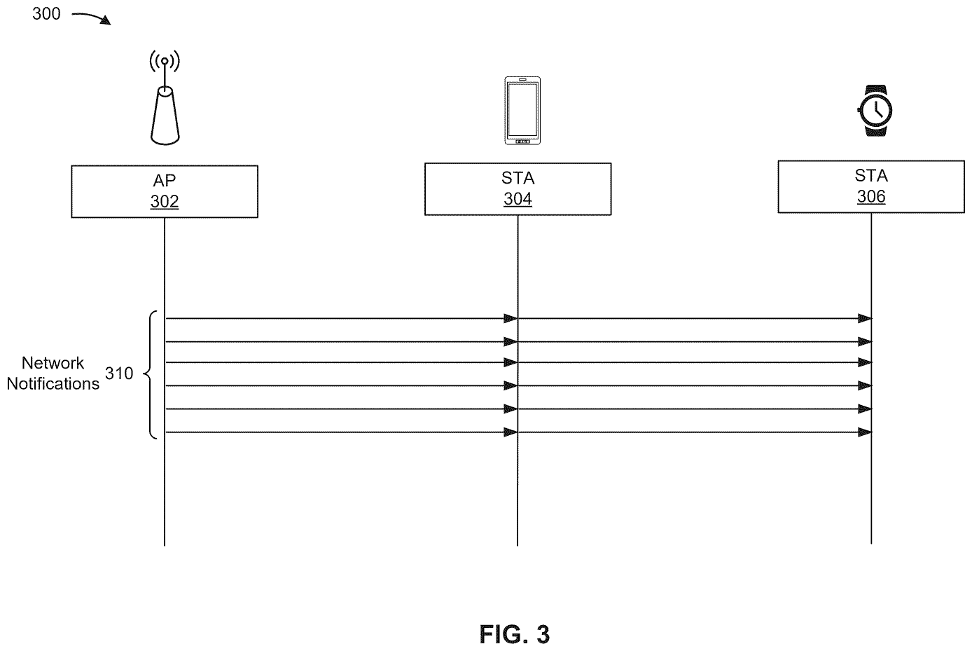

FIG. 3 is a diagram illustrating an example 300 of a critical update procedure, in accordance with the present disclosure.

An AP (e.g., an AP 102) may communicate updates to a wireless network configuration to one or more STAs (e.g., one or more STAs 104) to optimize a performance of the wireless network (e.g., increase data throughput, decrease data recovery errors, and/or decrease data transfer latencies) as an operating environment changes. To illustrate, the example 300 includes an AP 302 (e.g., an AP 102), a first STA 304 (e.g., a first STA 104) and a second STA 306 (a second STA 104). In a similar manner as described with regard to FIG. 1, the first STA 304 and the second STA 306 may each establish a respective access link connection with the AP 302 (e.g., the communication link 106-1 and the communication link 106-2) and a direct link with one another, such as by establishing a D2D link and/or a P2P link.

As shown by reference number 310, the AP 302 may transmit, and the first STA 304 and/or the second STA 306 may receive, one or more network notifications. As one example of a network notification, the AP 302 may transmit and/or broadcast one or more beacon frames at periodic intervals, and each beacon frame may include one or more parameters that indicate a wireless network configuration. In some cases, the parameters and/or the wireless network configuration may be associated with a critical update. While the AP 102 may transmit a critical update in a beam frame, other examples may include the AP 102 transmitting and/or indicating a network notification, such as the critical update, in other types of transmissions, such as a probe response, an action frame, an authentication and association frame, a control frame, a unicast frame, and/or a broadcast frame.

“Critical update” denotes explicit signaling from an AP to an STA that indicates an update and/or a change to one or more BSS parameters. An AP may transmit a critical update to dynamically indicate BSS changes that optimize performance in a WLAN. To illustrate, in a high-density operating environment that includes multiple STAs being connected to the AP, the AP may modify BSS coloring to reduce co-channel interference. As another example, the AP may modify BSS parameters that help load balancing and/or result in one or more STAs switching over to a less-congested AP. Accordingly, an AP may dynamically transmit a critical update based at least in part on dynamic changes to an operating environment, and each STA receiving the critical update may update one or more operating parameters used to communicate in the WLAN.

A critical update may include one or more elements that indicate a respective update to the WLAN configuration, and each critical update and/or critical update element may be classified into a category. A first example category may be referred to as a Category 1 critical update that indicates a change and/or update that is time sensitive. Some example Category 1 critical update elements may include a channel switch announcement element, an extended channel switch announcement element, a quiet element, a wide bandwidth channel switch element, a channel switch wrapper element, an operating mode notification element, and/or a quiet channel element. In some cases, a Category 1 critical update and/or a Category 1 critical update element may be associated with information that is directly included in a per-STA profile to ensure proper implementation or functionality.

A second example category may be referred to as a Category 2 critical update. A Category 2 critical update and/or a Category 2 critical update element may be less time sensitive relative to a Category 1 critical update and/or may indicate modifications to existing parameters. Some example Category 2 critical update elements that may be included in critical update signaling may include a dynamic network selection service (DNSS) parameter set, a high throughput (HT) operation element, an enhanced distributed channel access (EDCA) and/or Wi-Fi multimedia (WMM) parameters element, a very high throughput (VHT) operation element, a high efficiency (HE) operation element, an insertion of a broadcast target wake time (TWT) element, a BSS color change announcement element, a multi user (MU) EDCA parameter set element, an uplink orthogonal random access (UORA) parameter set element, and/or a an extremely high throughput (EHT) operation element. In some cases, a Category 2 critical update may be modified in a transmission frame body (e.g., a beacon frame body) and may indicate an update to a parameter of existing information at the STA.

As a first example, the AP may transmit a critical update by transmitting a first beacon frame that includes a channel switch announcement (CSA) information element (IE), and each STA that receives the first beacon frame may perform a corresponding action, such as by tuning to a new channel that is indicated by the CSA IE. As a second example, the AP may transmit a second beacon frame that includes modifications to a WMM IE, and each STA that receives the second beacon frame may adjust a quality of service (QoS) parameter to prioritize or deprioritize particular types of traffic as indicated by the WMM IE.

A premise of using critical updates is that the STAs receiving the critical updates take action and/or apply the indicated updates within a time window to ensure continuity the WLAN. For instance, for beacon frames that are periodically transmitted at a 100 millisecond (msec) beacon frame interval, an AP may transmit up to a pre-determined number of critical updates, such as by transmitting critical updates in five consecutive beam frames and/or ten consecutive beam frames (but no more). The pre-determined number of critical updates may be repetitions of one another and/or the AP may indicate a critical update counter in a transmission that counts down a remaining number of critical updates remaining in the pre-determined number. STAs operating in the WLAN that receive the critical updates may have a WLAN operating condition to adapt, apply, and/or complete changes associated with the critical updates within the time window (e.g., a 500 msec time window for the 100 msec beacon frame interval). While described with regard to a beacon frame interval, the time window for applying, adapting, and/or completing changes that are associated with the critical updates may be applicable to other types of transmission types, such as probe requests.

STAs operating with a same WLAN and/or connected to a same AP include varying capabilities. For instance, a first STA in the form of a mobile phone or a laptop may include more transceivers and/or antennas relative to a second STA that is in the form of a wearable device, such as a smart watch, and/or an IoT device. The second STA having fewer transceivers and/or antennas relative to the first STA may reduce the second STA's ability to mitigate receiver multipath effects relative to the first STA. As another example, the first STA may have a larger power supply (e.g., a battery with larger power storage) relative to the second STA. To preserve power that is stored in a battery, some STAs may operate in a power saving mode (PSM) that includes the STA alternating between a sleep state that reduces power consumption and an active state. To illustrate, in the sleep state, an STA may reduce an amount of power that is supplied to hardware and/or may be unable to transmit or receive communications and, in an active state, the STA may increase the amount of power that is supplied to hardware to enable transmission and/or reception by the STA. Some STAs may configure a duration of a sleep state based at least in part on a DTIM that is transmitted by an AP. As an example, a DTIM may be included in every n-th beacon frame (n being an integer) and may indicate when an STA should transition to the active state for data delivery (e.g., buffered data). To reduce power consumption, the STA may transition from a sleep state to an active state every n-th beacon frame to receive the DTIM. The STA may then analyze information indicated by the DTIM to determine whether to remain in the active state to receive any buffered data (e.g., broadcast data and/or multicast data) or whether to return to the sleep state.

“Low-power device” denotes a computing device (e.g., an STA) that includes a power source with a power storage level that satisfies a low power threshold. Examples of low-power devices may include a wearable device and/or an IoT device. In some cases, a low-power device may operate in a modified PSM mode that extends a sleep state and/or reduces the frequency of the low-power device transitioning to an active state to conserve more power, such as by extending the sleep state and not transitioning to the active state every n-th beacon frame to receive the DTIM. The extended sleep state may result in the low-power device missing critical updates. However, as described above, some low-power devices may be more susceptible to receiver multipath and/or less equipped to mitigate receiver multipath, and missing the critical update in combination with reduced receiver capabilities may lead to the low-power device operating out-of-sync with an AP and may result in increased data recovery errors, increased data transfer latencies (e.g., data stalling), decreased data throughput, and/or increased disconnects from the AP.

Various aspects relate generally to managing notifications in a wireless network. Some aspects more specifically relate to an access link management notification using a D2D link. In some aspects, a first STA may receive, in an access link with an AP, an access link management notification that indicates configuration information associated with the access link. For instance, the first STA may receive, as the link management notification, a beacon frame in the access link, and the beacon frame may include a critical update. Based at least in part on receiving the access link management notification, the first STA may transmit, in a D2D link with a second STA, an indication of the access link management notification.

In some aspects, a second STA may establish an access link with an access point and may establish a D2D link with a first STA. The second STA may receive, in the D2D link, an indication of an access link management notification that indicates configuration information associated with the access link.

Particular aspects of the subject matter described in this disclosure can be implemented to realize one or more of the following potential advantages. In some examples, by a first STA indicating an access link management notification to a second STA via a D2D link, the described techniques can be used to increase power savings at the second STA and mitigate the second STA missing a critical update. For instance, the second STA may register with the first STA to receive the access link management notifications via the D2D link and may extend a sleep state duration to reduce power consumption. The first STA may monitor for the access link management notifications and may forward the access link management notifications to the second STA during an active state of the second STA to ensure that the second STA has received critical updates and remains synchronized with a wireless network. Reducing power consumption at the second STA may extend an operating duration of the second STA and ensure that the second STA is synchronized in the wireless network, resulting in reduced recovery errors, increased data throughput, reduced data transfer latencies, and/or reduced disconnects.

As indicated above, FIG. 3 is provided as an example. Other examples may differ from what is described with regard to FIG. 3.

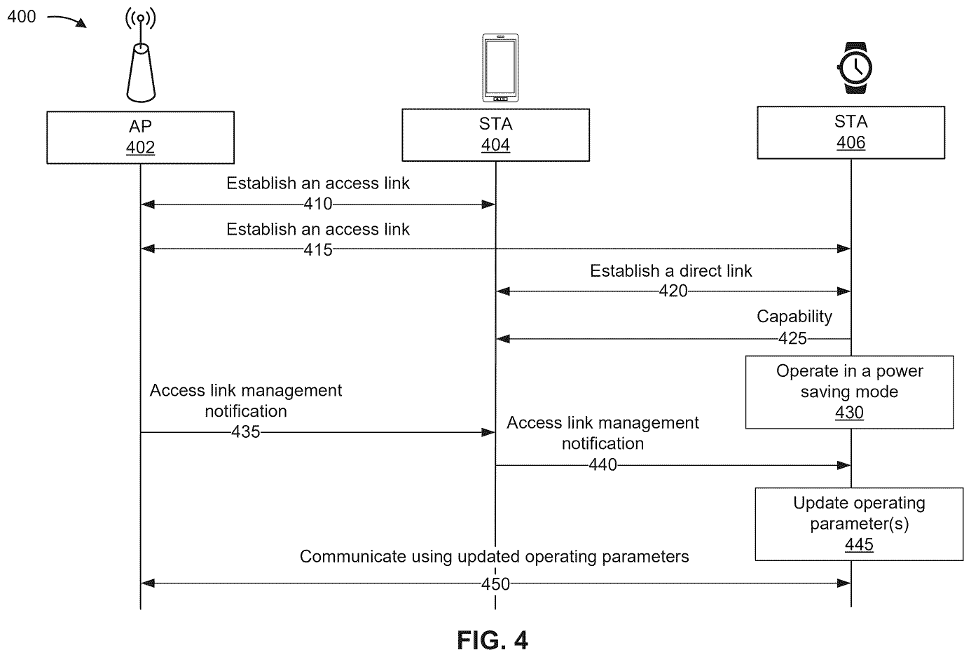

FIG. 4 is a diagram illustrating an example 400 of a wireless communication process between an AP 402 (e.g., an AP 102), a first STA 404 (e.g., a first STA 104), and a second STA 406 (e.g., a second STA 104), in accordance with the present disclosure.

As shown by reference number 410, an AP 402 may establish a first access link with a first STA 404. Alternatively, or additionally, the AP 402 may establish a second access link with a second STA 406 as shown by reference number 415. As one example, the first STA 404 and/or the second STA 406 may listen for one or more beacons transmitted by the AP 402. As another example, the first STA 404 and/or the second STA 406 may transmit a respective probe request and may listen for a respective probe response from the AP 402. Based at least in part on detecting the AP 402 and/or determining that the AP 402 is a qualified AP to establish a link with (e.g., by analyzing a beacon frame or a probe response), the first STA 404 and/or the second STA 406 may initiate a respective authentication process with the AP 402. Alternatively, or additionally, the first STA 404 and/or the second STA 406 may perform a respective association procedure with the AP 402 based at least in part on completing the authentication process. In some aspects, the first STA 404 and/or the second STA 406 may perform a respective security procedure with the AP 402, such as a security procedure to obtain an encryption key. The AP 402 may provide connectivity to a WLAN to the first STA 404 and/or the second STA 406 via the respective access link.

As shown by reference number 420, the first STA 404 and the second STA 406 may establish a D2D link. In some aspects, the D2D link may be based at least in part on a WPAN. For instance, the first STA 404 and the second STA 406 may establish a Bluetooth link, a BLE link, or any other suitable P2P group connection.

As shown by reference number 425, the second STA 406 may transmit, and the first STA 404 may receive, a registration message. To illustrate, the second STA 406 may transmit the registration message via the D2D link, and the registration message may be associated with receiving an access link management notification in the D2D link. Alternatively, or additionally, the second STA 406 may indicate support for receiving the access link management notification in the D2D link.

As shown by reference number 430, the second STA 406 may operate in a power saving mode. For instance, the second STA 406 may transition between operating in a sleep state and an awake state. Prior to operating in the power saving mode, the second STA 406 may indicate a periodicity and/or a duration of an awake state of the power saving mode to the first STA 404 via the D2D link, such as in the registration message. In some aspects, the second STA 406 may operate in the power saving mode based at least in part on transmitting the registration message via the D2D link.

As shown by reference number 435, the AP 402 may transmit, and the first STA 404 may receive, an indication of an access link management notification. In some aspects, the access link management notification may indicate configuration information and/or an update to one or more operating parameters associated with the first access link and/or the second access link (e.g., a WLAN access link). To illustrate, as described above, the access link management notification may be a critical update that indicates an update to one or more BSS parameters, such as a Category 1 critical update or a Category 2 critical update. The AP 402 may transmit the indication of the access link management notification as a broadcast message and/or a multicast message. Alternatively, or additionally, the AP 402 may transmit the access link management notification in the first access link and/or the second access link. In some aspects, the AP 402 may transmit the access link management notification in a beacon frame. In other aspects, the AP 402 may transmit the access link management notification in a probe response that is associated with a probe request from the first STA 404. Based at least in part on receiving the access link management notification, the first STA 404 may apply configuration information indicated in the access link management notification and/or may update the first access link based at least in part on the configuration information.

As shown by reference number 440, the first STA 404 may transmit, and the second STA 406 may receive, an indication of the access link management notification. As one example, based at least in part on the first STA 404 and the second STA 406 being connected via a D2D link, the first STA 404 may transmit the indication of the access link management notification in the D2D link. Alternatively, or additionally, the first STA 404 may transmit the indication of the access link management notification based at least in part on receiving the registration message from the second STA 406 and/or based at least in part on receiving a notification that the second STA 406 is operating in a power saving mode. In some aspects, the access link management notification may indicate configuration information and/or one or more parameter updates that are associated with the second access link between the second STA 406 and the AP 402 (e.g., a WLAN access link).

The access link management notification may be associated with a counter, such as a critical update counter that is a countdown counter that indicates a number of remaining critical updates in a pre-determined number of consecutive critical updates. The first STA 404 may transmit the indication of the access link management notification prior to expiration of the counter to ensure that the second STA 406 receives and/or applies the critical update within a time window.

As shown by reference number 445, the second STA 406 may update one or more operating parameters that are associated with the second access link. That is, the second STA 406 may update the second access link using configuration information indicated by the access link management notification, examples of which are provided above.

As shown by reference number 450, the AP 402 and the second STA 406 may communicate based at least in part on the updated operating parameters. To illustrate, as part of updating the second access link, the STA 406 may switch from a first communication channel to a second communication channel and/or may use updated BSS coloring, and the AP 402 and the second STA 406 may communicate with one another using the second communication channel or the updated BSS coloring.

A first STA indicating an access link management notification to a second STA via a D2D link may increase power savings at the second STA and mitigate the second STA missing a critical update. For instance, the second STA may register with the first STA to receive the access link management notifications via the D2D link and, consequently, may extend a sleep state duration to reduce power consumption. The first STA may monitor for the access link management notifications and may forward the access link management notifications to the second STA during an active state of the second STA to ensure that the second STA has received critical updates and remains synchronized with a wireless network. Reducing power consumption at the second STA may extend an operating duration of the second STA and ensure that the second STA is synchronized in the wireless network, resulting in reduced recovery errors, increased data throughput, reduced data transfer latencies, and/or reduced disconnects.

As indicated above, FIG. 4 is provided as an example. Other examples may differ from what is described with regard to FIG. 4.

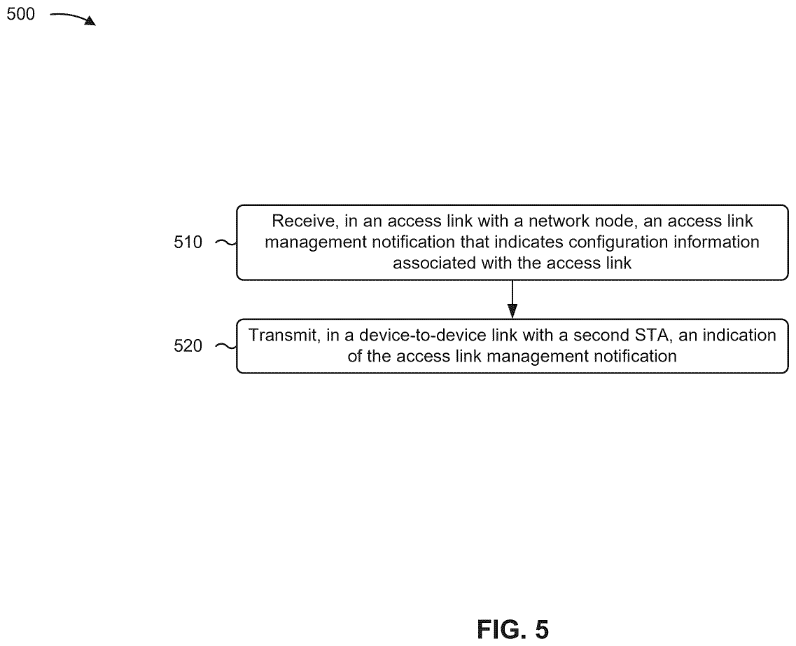

FIG. 5 is a flowchart of an example process 500 associated with access link management notification using a D2D link, in accordance with the present disclosure. In some aspects, one or more process blocks of FIG. 5 are performed by a first wireless station (e.g., a first STA 104). In some aspects, one or more process blocks of FIG. 5 are performed by another device or a group of devices separate from or including the first STA, such as a second wireless station (e.g., a second STA 104), an access point (e.g., AP 102), and/or a network (e.g., wireless communication network 110). Additionally, or alternatively, one or more process blocks of FIG. 5 may be performed by one or more components of device 200, such as processor 210, memory 215, input component 220, output component 225, and/or communication component 230.

As shown in FIG. 5, process 500 may include receiving, in an access link with an AP, an access link management notification that indicates configuration information associated with the access link (block 510). For example, the STA may receive, in an access link with an AP, an access link management notification that indicates configuration information associated with the access link, as described above.

As further shown in FIG. 5, process 500 may include transmitting, in a D2D link with a second STA, an indication of the access link management notification (block 520). For example, the STA may transmit, in a D2D link with a second STA, an indication of the access link management notification, as described above.

Process 500 may include additional aspects, such as any single aspect or any combination of aspects described below and/or in connection with one or more other processes described elsewhere herein.

In a first aspect, the access link management notification includes a critical update notification.

In a second aspect, the critical update notification is associated with a wireless local area network.

In a third aspect, the critical update notification indicates, as the configuration information, one or more basic service set parameter updates.

In a fourth aspect, the access link is based at least in part on a wireless local area network link.

In a fifth aspect, the D2D link is based at least in part on a wireless personal area network link.

In a sixth aspect, receiving the access link management notification includes receiving the access link management notification in a beacon frame.

In a seventh aspect, receiving the access link management notification includes receiving the access link management notification in a probe response.

In an eighth aspect, the access link management notification is associated with a counter, and transmitting the indication of the access link management notification includes transmitting the indication prior to expiration of the counter.

In a ninth aspect, process 500 includes receiving, in the D2D link, a registration message for receiving the access link management notification using the D2D link, and transmitting the indication of the access link management notification is based at least in part on receiving the registration message.

Although FIG. 5 shows example blocks of process 500, in some aspects, process 500 includes additional blocks, fewer blocks, different blocks, or differently arranged blocks than those depicted in FIG. 5. Additionally, or alternatively, two or more of the blocks of process 500 may be performed in parallel.

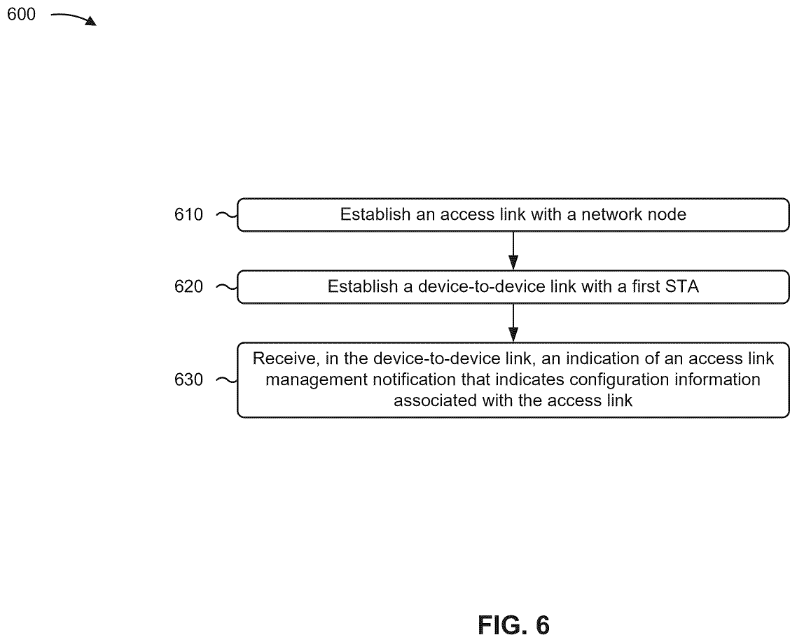

FIG. 6 is a flowchart of an example process 600 associated with access link management notification using a D2D link, in accordance with the present disclosure. In some aspects, one or more process blocks of FIG. 6 are performed by a second wireless station (e.g., a second STA 104). In some aspects, one or more process blocks of FIG. 6 are performed by another device or a group of devices separate from or including the second STA, such as a first wireless station (e.g., a first STA 104), an access point (e.g., AP 102), and/or a network (e.g., wireless communication network 110). Additionally, or alternatively, one or more process blocks of FIG. 6 may be performed by one or more components of device 200, such as processor 210, memory 215, input component 220, output component 225, and/or communication component 230.

As shown in FIG. 6, process 600 may include establishing an access link with an AP (block 610). For example, the STA may establish an access link with an AP, as described above.

As further shown in FIG. 6, process 600 may include establishing a D2D link with a first STA (block 620). For example, the STA may establish a D2D link with a first STA, as described above.

As further shown in FIG. 6, process 600 may include receiving, in the D2D link, an indication of an access link management notification that indicates configuration information associated with the access link (block 630). For example, the STA may receive, in the D2D link, an indication of an access link management notification that indicates configuration information associated with the access link, as described above.

Process 600 may include additional aspects, such as any single aspect or any combination of aspects described below and/or in connection with one or more other processes described elsewhere herein.

In a first aspect, process 600 includes updating the access link based at least in part on the indication of the access link management notification.

In a second aspect, the access link management notification includes a critical update notification.

In a third aspect, the critical update notification is associated with a wireless local area network.

In a fourth aspect, the critical update notification indicates, as the configuration information, one or more basic service set parameter updates.

In a fifth aspect, the access link is based at least in part on a wireless local area network link.

In a sixth aspect, the D2D link is based at least in part on a wireless personal area network link.

In a seventh aspect, process 600 includes transmitting, in the D2D link, a registration message for receiving the access link management notification using the D2D link, and receiving the indication of the access link management notification is based at least in part on receiving the registration message.

In an eighth aspect, process 600 includes operating in a power saving mode based at least in part on transmitting the registration message.

Although FIG. 6 shows example blocks of process 600, in some aspects, process 600 includes additional blocks, fewer blocks, different blocks, or differently arranged blocks than those depicted in FIG. 6. Additionally, or alternatively, two or more of the blocks of process 600 may be performed in parallel.

The following provides an overview of some Aspects of the present disclosure:

Aspect 1: A method of wireless communication performed by a first wireless station (STA), comprising: receiving, in an access link with an access point, an access link management notification that indicates configuration information associated with the access link; and transmitting, in a device-to-device (D2D) link with a second STA, an indication of the access link management notification.

Aspect 2: The method of Aspect 1, wherein the access link management notification comprises a critical update notification.

Aspect 3: The method of Aspect 2, wherein the critical update notification is associated with a wireless local area network.

Aspect 4: The method of Aspect 2 or Aspect3, wherein the critical update notification indicates, as the configuration information, one or more basic service set parameter updates.

Aspect 5: The method of any one of Aspects 1-4, wherein the access link is based at least in part on a wireless local area network link.

Aspect 6: The method of any one of Aspects 1-5, wherein the D2D link is based at least in part on a wireless personal area network link.

Aspect 7: The method of any one of Aspects 1-6, wherein receiving the access link management notification comprises: receiving the access link management notification in a beacon frame.

Aspect 8: The method of any one of Aspects 1-6, wherein receiving the access link management notification comprises: receiving the access link management notification in a probe response.

Aspect 9: The method of any one of Aspects 1-8, wherein the access link management notification is associated with a counter, and wherein transmitting the indication of the access link management notification comprises: transmitting the indication prior to expiration of the counter.

Aspect 10: The method of any one of Aspects 1-9, further comprising: receiving, in the D2D link, a registration message for receiving the access link management notification using the D2D link, wherein transmitting the indication of the access link management notification is based at least in part on receiving the registration message.

Aspect 11: A method of wireless communication performed by a second wireless station (STA), comprising: establishing an access link with an access point; establishing a device-to-device (D2D) link with a first STA; and receiving, in the D2D link, an indication of an access link management notification that indicates configuration information associated with the access link.

Aspect 12: The method of Aspect 11, further comprising: updating the access link based at least in part on the indication of the access link management notification.

Aspect 13: The method of Aspect 11 or Aspect 12, wherein the access link management notification comprises a critical update notification.

Aspect 14: The method of Aspect 13, wherein the critical update notification is associated with a wireless local area network.

Aspect 15: The method of Aspect 13 or Aspect 14, wherein the critical update notification indicates, as the configuration information, one or more basic service set parameter updates.

Aspect 16: The method of any one of Aspects 11-15, wherein the access link is based at least in part on a wireless local area network link.

Aspect 17: The method of any one of Aspects 11-16, wherein the D2D link is based at least in part on a wireless personal area network link.

Aspect 18: The method of any one of Aspects 11-17, further comprising: transmitting, in the D2D link, a registration message for receiving the access link management notification using the D2D link, wherein receiving the indication of the access link management notification is based at least in part on receiving the registration message.

Aspect 19: The method of Aspect 18, further comprising: operating in a power saving mode based at least in part on transmitting the registration message.

Aspect 20: An apparatus for wireless communication at a device, comprising a processor; memory coupled with the processor; and instructions stored in the memory and executable by the processor to cause the apparatus to perform the method of one or more of Aspects 1-10.
Aspect 21: A device for wireless communication, comprising a memory and one or more processors coupled to the memory, the one or more processors configured to perform the method of one or more of Aspects 1-10.

Aspect 22: An apparatus for wireless communication, comprising at least one means for performing the method of one or more of Aspects 1-10.

Aspect 23: A non-transitory computer-readable medium storing code for wireless communication, the code comprising instructions executable by a processor to perform the method of one or more of Aspects 1-10.

Aspect 24: A non-transitory computer-readable medium storing a set of instructions for wireless communication, the set of instructions comprising one or more instructions that, when executed by one or more processors of a device, cause the device to perform the method of one or more of Aspects 1-10.

Aspect 25: An apparatus for wireless communication at a device, comprising a processor; memory coupled with the processor; and instructions stored in the memory and executable by the processor to cause the apparatus to perform the method of one or more of Aspects 11-19.

Aspect 26: A device for wireless communication, comprising a memory and one or more processors coupled to the memory, the one or more processors configured to perform the method of one or more of Aspects 11-19.

Aspect 27: An apparatus for wireless communication, comprising at least one means for performing the method of one or more of Aspects 11-19.

Aspect 28: A non-transitory computer-readable medium storing code for wireless communication, the code comprising instructions executable by a processor to perform the method of one or more of Aspects 11-19.

Aspect 29: A non-transitory computer-readable medium storing a set of instructions for wireless communication, the set of instructions comprising one or more instructions that, when executed by one or more processors of a device, cause the device to perform the method of one or more of Aspects 11-19.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a first wireless station (STA), comprising:
one or more memories; and
one or more processors, coupled to the one or more memories, configured to cause the STA to:
receive, in an access link with an access point, an access link management notification that indicates configuration information associated with the access link; and
transmit, in a device-to-device (D2D) link with a second STA, an indication of the access link management notification.

2. The apparatus of claim 1, wherein the access link management notification comprises a critical update notification.

3. The apparatus of claim 2, wherein the critical update notification is associated with a wireless local area network.

4. The apparatus of claim 2, wherein the critical update notification indicates, as the configuration information, one or more basic service set parameter updates.

5. The apparatus of claim 1, wherein the one or more processors, to cause the STA to receive the access link management notification, are configured to cause the STA to:
receive the access link management notification in a beacon frame.

6. The apparatus of claim 1, wherein the one or more processors, to cause the STA to receive the access link management notification, are configured to cause the STA to:
receive the access link management notification in a probe response.

7. The apparatus of claim 1, wherein the access link management notification is associated with a counter, and
wherein the one or more processors, to cause the STA to transmit the indication of the access link management notification, are configured to cause the STA to:
transmit the indication prior to expiration of the counter.

8. The apparatus of claim 1, wherein the one or more processors are further configured to cause the STA to:
receive, in the D2D link, a registration message for receiving the access link management notification using the D2D link,
wherein transmitting the indication of the access link management notification is based at least in part on receiving the registration message.

9. A method of wireless communication performed by a first wireless station (STA), comprising:
receiving, in an access link with an access point, an access link management notification that indicates configuration information associated with the access link; and
transmitting, in a device-to-device (D2D) link with a second STA, an indication of the access link management notification.

10. The method of claim 9, wherein the access link management notification comprises a critical update notification.

11. The method of claim 10, wherein the critical update notification is associated with a wireless local area network.

12. The method of claim 10, wherein the critical update notification indicates, as the configuration information, one or more basic service set parameter updates.

13. The method of claim 9, wherein the access link is based at least in part on a wireless local area network link.

14. The method of claim 9, wherein the D2D link is based at least in part on a wireless personal area network link.

15. The method of claim 9, wherein receiving the access link management notification comprises:
receiving the access link management notification in a beacon frame.

16. The method of claim 9, wherein receiving the access link management notification comprises:
receiving the access link management notification in a probe response.

17. The method of claim 9, wherein the access link management notification is associated with a counter, and
wherein transmitting the indication of the access link management notification comprises:
transmitting the indication prior to expiration of the counter.

18. The method of claim 9, further comprising:
receiving, in the D2D link, a registration message for receiving the access link management notification using the D2D link,
wherein transmitting the indication of the access link management notification is based at least in part on receiving the registration message.

19. A non-transitory computer-readable medium storing a set of instructions for wireless communication, the set of instructions comprising:
one or more instructions that, when executed by one or more processors of a first wireless station (STA), cause the STA to:
receive, in an access link with an access point, an access link management notification that indicates configuration information associated with the access link; and
transmit, in a device-to-device (D2D) link with a second STA, an indication of the access link management notification.

20. The non-transitory computer-readable medium of claim 19, wherein the access link management notification comprises a critical update notification.
